(19) United States
(12) Patent Application Publication
(10) Pub. No.: US 2001/0032555 A1
(43) Pub. Date: Oct. 25, 2001

(54) Stencil printing apparatus

(76) Inventors: Takashi Isozaki, Ibaraki-ken (JP); Hirohide Hashimoto, Ibaraki-ken (JP)

Correspondence Address: FITCH, EVEN, TABIN & FLANNERY, 120 SOUTH LASALLE STREET, CHICAGO, IL, 60603-3406, US

(21) Appl. No.: 09/810,177

(22) Filed: Mar. 19, 2001

(30) Foreign Application Priority Data
Mar. 21, 2000 (JP) 078689/2000

(51) Int. Cl. B41L 13/00; B05C 17/06; B05C 17/08

(52) U.S. Cl. 101/119; 101/127

(57) ABSTRACT

A stencil printing apparatus prevented from being irregular in printing density between the central portion and the marginal portions of the printing area of a printing drum is provided. The stencil printing apparatus comprises a cylindrical printing drum having an ink-passable circumferential wall, an inner roller disposed inside the printing drum for supplying ink to an inner circumferential surface of the circumferential wall, and an outer roller disposed outside the printing drum in opposite to the inner roller. The inner roller is disposed at a gap of 0.9 mm or less, preferably 0.3 mm or less from the inner circumferential surface of the circumferential wall, and the outer roller is larger in diameter than the inner roller.

The present invention relates to a stencil printing apparatus which is prevented from being irregular in printing density.

In general, the printing drum of stencil printing apparatus is formed by bending a sheet-like member such as a perforated sheet, punched-metal screen or metallic screen processed by such a method as etching or electroforming into a cylindrical form, and fixing both the ends of the cylinder to flanges (see JP 8-267949A) or attaching flanges to both the ends of a porous member that has previously been formed cylindrically.

Such a printing drum is provided with a stencil mount and a clamp plate pivotally installed on the mount for clamping and holding one end of a perforated stencil sheet as a printing plate. Thus, the area near the mount of the circumferential wall of the printing drum is formed as an ink-impassable area (hereinafter called “non-printing area”), and the other area is formed as an ink-passable area (hereinafter called “printing area”). Inside the printing drum, an inner roller is disposed adjacent to the circumferential wall of the printing drum, so that when the printing drum is rotated around the central axis thereof, ink introduced into the printing drum can be supplied to the circumferential wall from the inner circumferential surface thereof. Furthermore, outside the printing drum, an outer roller is disposed at a position in opposite to the inner roller. Thus, if a printing sheet is held between the printing drum and the outer roller and is conveyed in synchronization with rotation of the printing drum, ink is fed through the printing area of the circumferential wall of the printing drum and through the stencil sheet and transferred onto the printing sheet. In this way, printing is performed.

In the conventional stencil printing apparatus as described above, if the gap between the inner roller and the inner circumferential surface of the printing drum is too narrow, an excessive amount of ink is supplied to the circumferential wall of the printing drum, and ink is collected in the gap between the stencil sheet and the outer circumferential surface of the printing drum, whereby the ink leaks out therefrom for staining printing sheets, causing so-called “side leakage” or “end leakage”.

It may be considered to form a proper gap, between the inner roller and the printing drum for preventing the ink leakage.

However, in the above-mentioned printing drum, the printing area has numerous holes formed to allow the passage of ink. On the contrary, the non-printing area has no hole to prevent scattering of ink and furthermore is provided with the mount and the like. Thus, rigidity of the circumferential wall is different between the printing area and the non-printing area. Therefore, when the outer roller and the printing drum are pressed to each other for holding a printing sheet at the time of printing, pressure acting on the printing sheet is different between the printing areas and the non-printing area. Especially in the case where the gap between the inner roller and the inner circumferential surface of the printing drum is too large, a large pressure difference occurs near the border between both the areas, i.e., near the marginal portions of the printing area, causing a problem that a printing density difference occurs between the central portion and the marginal portions of the printing sheet. This problem is remarkable especially in the case where the circumferential wall of the printing drum is formed with a highly rigid member processed by such a method as etching or electroforming.

The object of this invention is to provide a stencil printing apparatus that allows printing uniform in density between the central portion and the marginal portions of printing sheets even in the case where a gap is formed between the inner roller and the printing drum.

According to this invention, the above object can be achieved by a stencil printing apparatus which comprises a cylindrical printing drum having an ink-passable circumferential wall, an inner roller disposed inside the printing drum for supplying ink to an inner circumferential surface of the circumferential wall, and an outer roller disposed outside the printing drum in opposite to the inner roller, whereby printing is performed by rotating the printing drum around a central axis thereof with a perforated stencil sheet being wound around an outer circumferential surface of the circumferential wall while a printing sheet fed in synchronization with the rotation of the printing drum is held between the printing drum and the outer roller, characterized in that a gap of 0.9 mm or less, preferably 0.3 mm or less is formed between the inner roller and the inner circumferential surface of the circumferential wall and that the diameter of the outer roller is larger than the diameter of the inner roller.

In this invention, since a gap of 0.9 mm or less is formed between the inner roller and the inner circumferential surface of the circumferential wall of the printing drum, the circumferential wall of the printing drum is less deformed when the printing sheet is held between the outer roller and the printing drum, thereby decreasing the pressure difference between the printing area and the non-printing area and as a result decreasing the printing density difference between the central portion and the marginal portions of the printing area. Furthermore, if the gap between the inner roller and the inner circumferential surface of the circumferential wall of the printing drum is kept to be 0.3 mm or less, the pressure difference between the printing area and the non-printing area is further decreased, thereby allowing a uniform image free from printing density difference to be printed on printing sheets.

In addition, in this invention, since the diameter of the outer roller is larger than the diameter of the inner roller, the circumferential wall of the printing drum contacts the outer roller at a nipping portion wider than the inner roller. Therefore, the outer roller acts to press back the excessive ink existing between the stencil sheet and the outer circumferential surface of the printing drum toward the inside of the printing drum. So, it does not happen that excessive ink gathers between the stencil sheet and the outer circumferential surface of the printing drum, thereby effectively preventing the ink from leaking cut therefrom.

In the stencil printing apparatus of this invention, to hold a printing sheet between the printing drum and the outer roller, the outer roller may be moved toward the printing drum to press the outer roller to the printing drum, or the printing drum may be moved toward the outer roller to press the printing drum to the outer roller. Furthermore, both may be moved toward each other for pressing them to each other.

An embodiment of the stencil printing apparatus of this invention is described below in reference to the drawings. In the drawings,

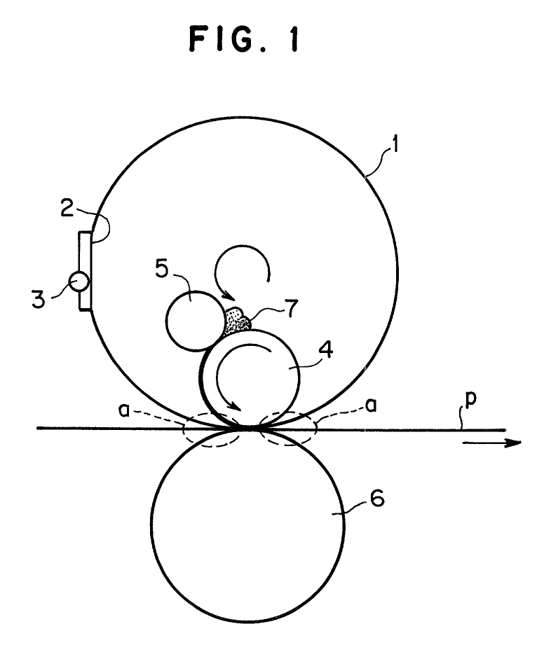

FIG. 1 is a sectional view showing an embodiment of the stencil printing apparatus of this invention, and

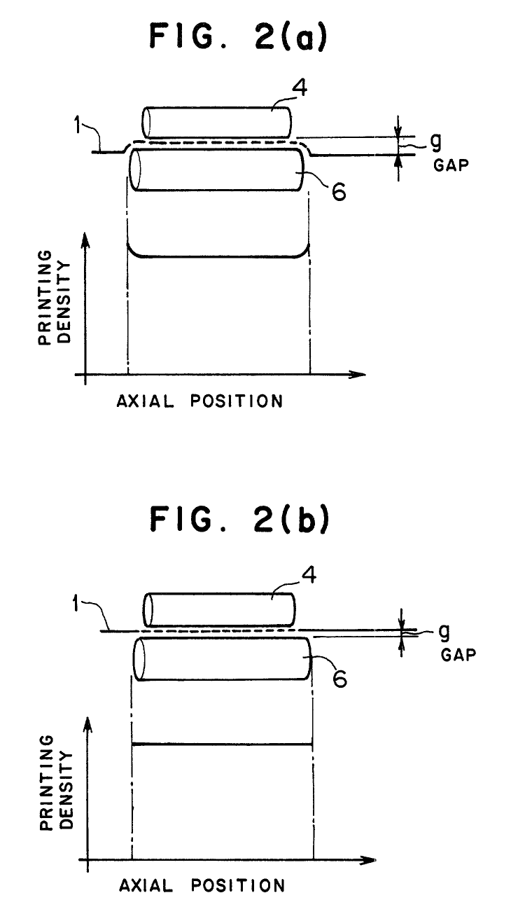

FIG. 2(a) and FIG. 2(b) are graphs showing the relation between the position in the axial direction of a printing drum on a print obtained using a stencil printing apparatus and the printing density and also showing sectional views in the central axial direction near the circumferential wall of the printing drum.

As shown in FIG. 1, a printing drum 1 is formed by bending a sheet-like member such as a punched-metal screen or metallic screen into a cylindrical form, fixing both the ends of it to flanges, and winding a single-layer or multi-layer screen having a fine mesh structure around it. On the outer circumferential surface of the printing drum 1, a stencil mount 2 is installed along a generating line of the outer circumferential surface, and the mount 2 is provided with a swingable clamp plate 3 thereon, so that a perforated stencil sheet can be held at one end thereof between the mount 2 and the clamp plate 3 and wound around the outer circumferential surface of the circumferential wall of the printing drum 1. The mount 2 and the vicinity thereof are formed as an ink-impassable area, i.e., non-printing area, while the other area of the circumferential wall of the printing drum 1 is formed as an ink-passable area, i.e., printing area.

The printing drum 1 is rotatably mounted to a frame not illustrated, and is internally provided with a squeegee roller as an inner roller 4. The inner roller 4 is disposed to extend in parallel to an axial line of the printing drum with a slight gap kept from the inner circumferential surface of the circumferential wall of the printing drum 1. Furthermore, the printing drum 1 is internally provided with a doctor roller 5 which is disposed diagonally above and in parallel to the inner roller 4 with a slight gap kept from the inner roller 4. Outside the printing drum 1, an outer roller 6 is disposed in parallel to the inner roller 4. The outer roller 6 can reversibly ascend to and descend from the printing drum 1, and functions as a press roller for pressing a printing sheet P to the outer circumferential surface of the printing drum 1 at the time of printing. The diameter of the outer roller 6 is larger than the diameter of the inner roller 4.

At the time of printing, if the printing drum 1 is rotated around the central axial line thereof by a drive means not illustrated, the inner roller 4 rotates in the same direction as the printing drum 1, to supply the ink introduced in the printing drum 1 from the inner circumferential surface of the printing drum 1 to the circumferential wall thereof. In this case, excessive ink is collected between the inner roller 4 and the doctor roller 5, to form an ink vortex 7, for incessantly supplying a constant quantity of ink to the circumferential wall of the printing drum 1. When printing sheet E is fed between the printing drum 1 and the outer roller 6 in synchronization with the rotation of the printing drum 1, and is pressed to the outer circumferential surface of the printing drum 1 by the outer roller 6, ink is transferred to the printing sheet P through the circumferential wall of the printing drum 1 and a perforated stencil sheet (not illustrated) wound around the circumferential wall, thereby achieving printing.

According to experiments performed by the inventors, in the above-mentioned process, as shown in FIG. 2 (a), in the case where the gap g between the inner roller 4 and the inner circumferential surface of the printing drum 1 is too large, the circumferential wall of the printing drum 1 is greatly deflected inwardly by pressure of the outer roller 6. So, printing density rises near the marginal portions of the printing area, to cause irregular printing. On the other hand, in the case where the gap g between the inner roller 4 and the inner circumferential surface of the printing drum 1 is small, the pressure of the outer roller 6 less deflects the circumferential wall of the printing drum 1 inwardly. So, the printing density does not rise even near the marginal portions of the printing area, to allow an image uniform in density to be printed.

Furthermore, in this embodiment, since the diameter of the outer roller 6 is larger than the diameter of the inner roller 4, the nipping portion a of the outer roller 6 with the circumferential wall of the printing drum 1 are wider than the nipping portion of the inner roller 4 with the circumferential wall of the printing drum 1 as shown in FIG. 1. Therefore, even if excessive ink is contained between the stencil sheet and the outer circumferential surface of the printing drum, the outer roller 6 presses it back to the inside of the printing drum 1, for preventing ink leakage. Usually it is desirable that the diameter of the inner roller is 20 to 80 mm, and that the diameter of the outer roller is 30 to 220 mm.

In this invention, the materials, production methods, sizes and others of the printing drum, the inner roller and the outer roller can be selected arbitrarily and are not limited to those described in this embodiment or the following examples.

### EXAMPLES

### Example 1

A sheet processed by nickel-electroforming with a thickness of 0.2 mm, a hole diameter of 0.2 mm and an opening ratio of 12% was used to form a printing drum with a circumferential wall having a diameter of 180 mm. As the inner roller, an aluminum roller having a diameter of 50 mm was prepared, and as the outer roller, a rubber roller having a diameter of 60 mm was prepared. A stencil printing apparatus shown in FIG. 1 was fabricated by modifying a stencil printing apparatus RISOGRAPH (registered trademark) GR377 (produced by Riso Kagaku Corporation) using these parts. With the gap between the inner roller and the inner circumferential surface of the printing drum changed variously, 500 sheets were continuously printed at an ambient temperature of 23° C. respectively, and the printed image irregularity at the marginal portions of the printing area, and the ink collected between the stencil sheet and the outer circumferential surface of the printing drum were visually observed.

The results are shown in Table 1.

### Example 2

An experiment was performed for evaluation as described for Example 1, except that a rubber roller having a diameter of 180 mm was used as the outer roller.

### Comparative Example 1

An experiment was performed for evaluation as described for Example 1, except that a rubber roller having a diameter of 40 mm was used as the outer roller.

TABLE 1

| | | | | Comparative |
|---|---|---|---|---|
| | | Example 1 | Example 2 | Example 1 |
| | Diameter of | | | |
| | inner roller | 50 (mm) | ← | ← |
| | Diameter of | | | |
| | outer roller | 60 (mm) | 180 (mm) | 40 (mm) |
| Gap between inner | 1.0 (mm) | Δ | Δ | Δ |
| roller and inner | 0.7 (mm) | ∘ | ∘ | ∘ |
| circumferential | 0.3 (mm) | ∘ | ∘ | x |
| surface of printing | 0.0 (mm) | ∘ | ∘ | x |
| drum | | | | |

In Table 1, ∘, Δ and X mean the following:

∘: Printed image irregularity was not outstanding, and ink was not collected between the stencil sheet and the outer circumferential surface of the printing drum.

Δ: Printed image irregularity occurred, but ink was not collected between the stencil sheet and the outer circumferential surface of the printing drum.

X: Printed image irregularity was not outstanding, but ink was collected between the stencil sheet and the outer circumferential surface of the printing drum.

According to this invention, since the gap between the inner roller and the inner circumferential surface of the printing drum is kept to be 0.9 mm or less, the circumferential wall of the printing drum is less deformed when a printing sheet is held between the outer roller and the printing drum, thereby decreasing the pressure difference between the printing area and the non-printing area of the circumferential wall of the printing drum, and as a result decreasing the printing density difference between the central portion and the marginal portions of the printing area. Furthermore, if the gap between the inner roller and the inner circumferential surface of the printing drum is kept to be 0.3 mm or less, the pressure difference between the printing area and the non-printing area is further decreased, and prints having a uniform image free from printing density difference can be obtained.

In addition, since the diameter of the outer roller is larger than the diameter of the inner roller, the nipping portion of the outer roller with the circumferential wall of the printing drum are wider than that of the inner roller. So, the outer roller presses back the excessive ink existing between the stencil sheet and the printing drum toward the inside of the printing drum, thereby preventing the ink being collected there and as a result preventing the side or end leakage of ink and the resultant staining of printing sheets.

1. A stencil printing apparatus which comprises a cylindrical printing drum having an ink-passable circumferential wall, an inner roller disposed inside said printing drum for supplying ink to an inner circumferential surface of said circumferential wall, and an outer roller disposed outside said printing drum in opposite to said inner roller, whereby printing is performed by rotating the printing drum around a central axis thereof with a perforated stencil sheet being wound around an outer circumferential surface of the circumferential wall while a printing sheet fed in synchronization with the rotation of the printing drum is held between the printing drum and the outer roller, wherein said inner roller is disposed at a gap of 0.9 mm or less from said inner circumferential surface of said circumferential wall, and said outer roller is larger in diameter than said inner roller.

2. A stencil printing apparatus according to claim 1, in which said gap between said inner roller and said inner circumferential surface of said circumferential wall is 0.3 mm or less.

3. A stencil printing apparatus according to claim 1, in which said outer roller is capable of being moved toward said printing drum to hold a printing sheet between said printing drum and said outer roller.

4. A stencil printing apparatus according to claim 1, in which said printing drum is capable of being moved toward said outer roller to hold a printing sheet between said printing drum and said outer roller.
